(19) United States
(12) Patent Application Publication
(10) Pub. No.: US 2012/0284576 A1
(43) Pub. Date: Nov. 8, 2012

(54) HARDWARE STIMULUS ENGINE FOR MEMORY RECEIVE AND TRANSMIT SIGNALS

(76) Inventors: Oswin E. Housty, Austin, TX (US); Harold H. Bautista, Austin, TX (US); Shawn Searles, Austin, TX (US)

(21) Appl. No.: 13/102,975

(22) Filed: May 6, 2011

(51) Int. Cl. G06F 11/267; G06F 12/00

(52) U.S. Cl. 714/718; 711/155; 711/E12.001; 714/E11.162

(57) ABSTRACT

Techniques and structures are disclosed in which memory training for DDR or other memory can be performed more rapidly. A memory controller is configured so that one or more memory parameters (e.g., timing delay) can be determined for one or more hardware elements such as delay locked loops (DLLs). Training may be performed without intermediation by (or reporting of results to) a system BIOS. Thus, training may be performed fully in hardware. Voltage training techniques are also disclosed.

### BACKGROUND

1. Technical Field

This disclosure generally relates to memory for computing devices. More specifically, this disclosure relates to testing and/or determination of operating parameters for computing device memory.

2. Description of the Related Art

In many computer architectures, a computer processor is connected to computer memory through a bus. In order to accurately perform memory reads or writes, it may be necessary to delay a memory data signal to synchronize it with a memory control signal. The control signal may be a signal, for example, indicating when to access a bitstream. Because the control signal and data signal may arrive out of phase, using a delay value to synchronize the two signals back together can reduce error. (Synchronization may prevent the bitstream from being erroneously sampled in the middle of a bit transition from high-to-low or low-to-high). Further, different portions of memory may operate in a different fashion due to varying physical characteristics of the memory, the data lines (or busses) connected to the memory, and/or the overall operating environment.

Memory access may thus be provided via several delay-locked loops (DLLs). Each DLL may govern memory access to one portion of memory, and may be tunable to a particular delay setting to synchronize memory data with memory control. Calibrating appropriate values for the various DLLs timing delay parameters may ensure data is accurately written to, and read from, all portions of computer memory. Determining the delay settings can be time consuming, however, particularly at higher memory operating frequencies.

### SUMMARY OF EMBODIMENTS

In one embodiment, a memory controller comprising a control circuit and a parameter adjustment circuit is disclosed. The control circuit is configured to perform a test of a memory element using one or more memory training parameters, and the parameter adjustment circuit is configured to receive an intermediate result of the test and adjust at least one of the one or more memory training parameters based on the intermediate result.

In another embodiment, a method is disclosed, comprising a memory controller performing a plurality of trials of a memory element, wherein an initial one of the plurality of trials uses a first value for a timing parameter, wherein subsequent ones of the plurality of trials each use a respectively different value for the timing parameter, and wherein the respectively different value is determined by the memory controller based on results of one or more previously performed ones of the plurality of trials of the memory element. The method also comprises the memory controller determining an operating value for the timing parameter based on results of the plurality of trials.

In another embodiment, an apparatus is disclosed, the apparatus comprising means for performing a test of a memory element using one or more memory training parameters and means for receiving an intermediate result of the test and adjusting at least one of the one or more memory training parameters based on the intermediate result.

In another embodiment, a computer readable storage medium is disclosed, comprising a data structure which is operated upon by a program executable on a computer system, the program operating on the data structure to perform a portion of a process to fabricate an integrated circuit including circuitry described by the data structure, the circuitry described by the data structure including a control circuit configured to perform a test of a memory element using one or more memory training parameters and including a parameter adjustment circuit configured to receive an intermediate result of the test and adjust at least one of the one or more memory training parameters based on the intermediate result.

The teachings of this disclosure, as well as the appended claims, are expressly not limited by the features and embodiments discussed above in this summary.

### BRIEF DESCRIPTION OF THE DRAWINGS

FIG. 1A is a block diagram illustrating a memory controller connected to a computer memory element via an input/output (“I/O”) circuit.

FIG. 1B is a block diagram showing one embodiment of I/O circuit.

FIG. 2 is a block diagram illustrating embodiments of a parameter adjustment circuit and a control circuit.

FIG. 3 illustrates a flowchart of a method for determining a memory parameter operating value.

FIG. 4 is a block diagram illustrating one embodiment of an exemplary computer system.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “An apparatus comprising one or more processor units . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a “first” memory parameter value and a “second” memory parameter value can be used to refer to any two values, and does not imply that one value is higher than another, or that one value was determined prior to the other. In other words, “first” and “second” are descriptors.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Processor.” This term has its ordinary and accepted meaning in the art, and includes a device that is capable of executing instructions. A processor may refer, without limitation, to a central processing unit (CPU), a co-processor, an arithmetic processing unit, a graphics processing unit, a digital signal processor (DSP), etc. A processor may be a superscalar processor with a single or multiple pipelines. A processor may include a single or multiple cores that are each configured to execute instructions.

“BIOS” or “BIOS device.” This term has its ordinary and accepted meaning in the art, and includes a memory or storage device (such as an EPROM or EEPROM) having stored thereon computer instructions that are executable by a processor of a computer system, independent of an operating system of the computer system, to change hardware system settings, power settings, order of boot device settings, etc.

“Memory training parameter” or “memory parameter.” As used herein, these terms refer to any parameter affecting the operation of memory reads and/or memory writes.

A computer system may contain a memory controller that is connected to one or more memory controller channels (MCCs) that interface with a memory bus. (For example, an x86 processor may have a memory controller in its Northbridge that is connected to a DRAM controller channel.) The MCCs may contain circuits that delay a transmitter and receiver in a fractional manner to ensure that writes from the controller and reads from the memory work correctly. Some delay values may work better than others, and may allow the memory to operate at a higher frequency. The process of determining appropriate delay values thus may help a system achieve peak performance. One way in which this process can be accomplished is by having BIOS read data from and write data to a memory controller channel while dynamically adjusting delays in the transmitter and receivers via PCI accesses (e.g., through a Southbridge). This is an example of a dynamic process called “memory training”.

During memory training, the memory controller may write data to memory, then read the data back and compare it with the previously data written to determine if the processor wrote or read the data using correct delay settings. After a failed comparison, a new delay setting may be used for the channel controller, and the process may be repeated until the comparisons are correct. However, when large amounts of memory are attached to a memory controller, training time may be significantly increased, particularly when numerous PCI accesses are carried out by BIOS (as BIOS may be required to poll on completion bits to determine that an access is complete for a particular delay setting before moving on to test another, different delay setting). For additional information, refer to U.S. Patent Publication No. 2009/0244997 (corresponding to U.S. application Ser. No. 12/059,653) and U.S. Patent Publication No. 2010/0325372 (corresponding to U.S. application Ser. No. 12/486,488), herein incorporated by reference their entireties. The present disclosure includes structures and techniques that may allow memory training to be performed more rapidly. In one embodiment, memory training is performed without intermediation from BIOS.

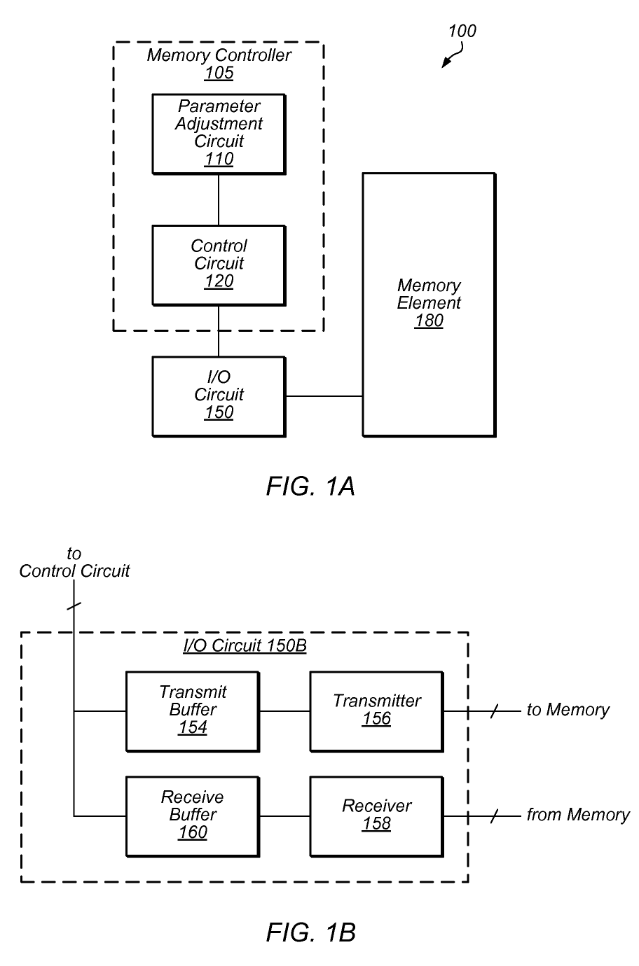

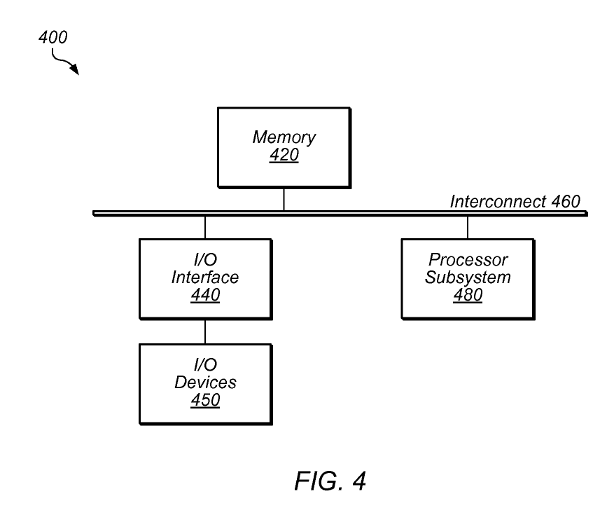

Turning now to FIG. 1A, a block diagram 100 is shown, in which a memory controller 105 is connected to a computer memory element 180 via an input/output (“I/O”) circuit 150. Memory element 180 comprises one or more memory storage elements that may be within a computer system such as system 400 (described below with respect to FIG. 4). In one embodiment, memory element 180 is one or more modules of dynamic random access memory (DRAM), but may be any other type of memory configured to store data in other embodiments. In one embodiment, memory element 180 is a DDR2 or DDR3 DRAM. Accordingly, memory element 180 comprises a plurality of groups of storage bytes. Access to memory element 180 (and these groups of storage bytes) is provided through I/O circuit 150.

An embodiment of I/O circuit 150 is shown in the block diagram of FIG. 1B. In FIG. 1B, an I/O circuit 150B is configured to couple to control circuit 120 and memory element 180, and includes a transmit buffer 154, transmitter 156, receiver 158, and receive buffer 160. In some embodiments, I/O circuit 150 includes multiple ones of any or all of buffer 154, transmitter 156, receiver 158, and receive buffer 160. In some embodiments, transmitter 156 and receiver 158 are combined into a single transceiver structure, such as described in U.S. Publication 2009/0244997. Accordingly, many configurations of I/O circuit 150 are possible.

Information to be written to memory element 180 may be stored in transmit buffer 154 prior to being sent via transmitter 156. Transmitter 156 may include (or be connected) to one or more delay-locked loops, each of which may be used to synchronize writing to one or more portions (groups of storage bytes) of memory element 180. Each DLL within transmitter 156 (or each DLL across multiple transmitters 156) may be governed by a different timing parameter value. For example, a first DLL may match a memory data signal (DQ) with a memory data strobe signal (DQS) according to a first timing value, while another DLL may match DQ with DQS using a second, different timing value. Likewise, receiver(s) 158 may include one or more DLLs that also match DQ with DQS according to one or more timing delay values. In some embodiments, DLLs in transmitter 156 and receiver 158 may be shared. More generally, transmitter(s) 156, receiver(s) 158, and/or the DLLs contained therein (or to which transmitter 156 and receiver 158 are configured to connect) may have any or all of the characteristics of the transmitters, receivers, transceivers, and DLLs described in the '997 publication and/or '372 publication.

Turning back to FIG. 1A, as shown, memory controller 105 includes a parameter adjustment circuit 110 and a control circuit 120. Parameter adjustment circuit 110 is configured to initiate a test of one or more memory elements in the embodiment of FIG. 1A. In one embodiment, an indication to begin the memory test is received by parameter adjustment circuit 110 from another component, such as a BIOS device or a processor. In other embodiments, parameter adjustment circuit 110 may be configured to initiate the memory test automatically (e.g., in response to a computer system containing circuit 110 being powered on). In yet further embodiments, parameter adjustment circuit 110 may be configured to initiate (or re-initiate) a test of one or more memory elements in response to a trigger event, such as a detected change in environmental conditions (e.g., raised or lowered temperature; raised or lowered voltage), a command from software (e.g., the operating system or BIOS), or a timer, either hardware or software based, which may use any combination of fixed-length and/or variable-length timings. In some embodiments, control circuit 120, rather than parameter adjustment circuit 110, is configured to initiate the memory test.

Generally, any or all of the structures and functions described herein with respect to parameter adjustment circuit 110 and control circuit 120 may be preferentially located in other circuitry. Thus, in some embodiments, all or a portion of parameter adjustment circuit 110 and control circuit 120 (and the functionality contained therein) may be located outside of memory controller 105. In some embodiments, all or a portion of parameter adjustment circuit 110 (and the functionality contained therein) may be located within control circuit 120, and vice versa. Further, all or a portion of I/O circuit 150 (and the functionality contained therein) may be located within memory controller 105, memory element 180, and/or other structures not explicitly described herein.

In the embodiment of FIG. 1A, control circuit 120 is configured to perform a test of one or more memory elements using one or more memory training parameters. In one embodiment, the one or more memory training parameters include one or more timing parameters. These timing parameters may be used to govern the behavior of one or more DLLs used for reading from and/or writing to memory element 180. For example, a given DLL may delay a DQ signal by a certain fraction (or multiple) of a clock cycle in order to better align the DQ signal with a corresponding DQS signal (alternatively, a DQS signal may be delayed with respect to a DQ signal, in some embodiments). In another embodiment, the one or more memory training parameters used for the test of the one or more memory elements include one or more voltage parameters, such as an operating voltage (or nominal peak voltage) of a memory channel.

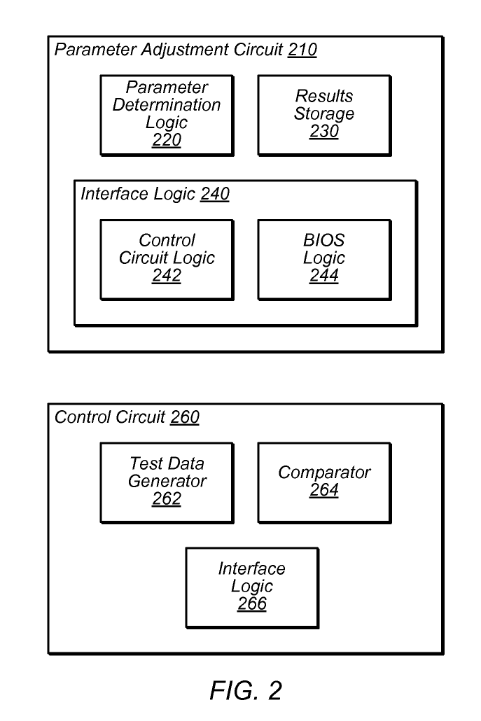

Turning now to FIG. 2, a block diagram is shown of a parameter adjustment circuit 210 and a control circuit 260. These circuits may have any of the features, structures, or functionality of parameter adjustment circuit 110 and control circuit 120 described above, and vice versa. As shown, parameter circuit 210 includes parameter determination logic 220, results storage 230, and interface logic 240, while control circuit 260 includes a test data generator 262, a comparator 264, and interface logic 266. As noted above with respect to circuits 110 and 120, all or a portion of circuit 210 (and the functionality contained therein) may be located in circuit 260, or vice versa. In one embodiment, a common circuit includes all structures and functionality described with respect to circuits 210 and 260.

Parameter adjustment circuit 210 is configured to determine one or more operating values for one or more memory training parameters. As used herein, the term “operating value” refers to a value used as part of normal computing operations (as opposed to a value used exclusively for purposes of testing or calibration). Operating values and testing values may, of course, have the same numeric value or fall within the same numeric range. In the embodiment of FIG. 2, parameter determination logic 220 is configured to determine an operating value based on intermediate results stored in results storage 230. In one embodiment, a plurality of intermediate results of a test of a memory element are used by parameter adjustment circuit 210 to determine one or more parameter operating values. Intermediate results of a memory test are delivered to storage 230 by control circuit 260 via interface logic 240 in one embodiment. In the embodiment of FIG. 2, interface logic 240 includes a portion 242 for communicating with control circuit 260 as well as a portion 244 for communicating with BIOS (for example, receiving an indication to begin testing).

Test data generator 262 is configured, in the embodiment of FIG. 2, to generate testing data for a test of a memory element using one or more memory training parameters. In one embodiment, generator 262 is a pattern generator, and is capable of generating large amounts of data (e.g., hundreds of megabytes or more) based on one or more preconfigured patterns or sequences. In some embodiments, all generated test data, or a portion thereof, may be generated randomly or pseudo-randomly. Some data patterns include portions designed to test difficult edge cases (for example, a certain consecutive number of zeros followed by a single one, followed again by a number of consecutive zeros may make the “one” bit harder to detect, and vice versa).

In the embodiment of FIG. 2, interface logic 266 is used to write data to memory element 180 (e.g., via I/O circuit 150) using one or more current (test) values for one or more memory training parameters. After test data is written to memory element 180, the data is read back from memory (e.g., via receiver 158 and receiver buffer 160). In some embodiments, the process of reading test data may overlap with the process of writing the test data (i.e., not all test data needs to be written to memory element 180 before reading can begin in these embodiments). Comparator 264 includes circuit logic to determine if the test data read from memory (incoming data) is the same as the test data that was written to memory (outgoing data), and to generate intermediate results therefrom. These intermediate results may then be reported to and stored by results storage 230. The process of writing test data to memory and reading it back is referred to herein as a “read/write trial.” In some embodiments, a read/write trial also includes other additional operations, such as generating one or more intermediate results.

The types and richness of the intermediate result data generated by comparator 264 may vary by embodiment. In some embodiments, comparator 264 is configured to simply generate a pass/fail indication as to whether the incoming test data was completely identical to the outgoing test data for the given memory training parameter(s). In other embodiments, comparator 264 may generate a pass result if a threshold amount or percentage of data is correct (e.g., no more than 1 bit error or byte error per 1 GB of test data). In yet further embodiments, comparator 264 may generate quantitative data indicating the number of bit errors or byte errors that occurred during a read/write trial, and/or the location of the errors within the test data pattern (for example, indicating which particular cases may have caused a failure).

Based on one or more intermediate results corresponding to one or more memory training parameters, parameter adjustment circuit 210 is configured to adjust at least one of the memory training parameters. For example, in one embodiment, parameter adjustment circuit 210 is configured to begin a test of memory element 180 using a given timing parameter value for a given DLL (such as a zero offset delay value between DQ and DQS for that DLL). Upon completion of the initial read/write trial using the given value, parameter adjustment circuit may increase the given value by a fixed amount (e.g., incrementing the offset between DQ and DQS for the given DLL by 1/32 of a clock cycle). A subsequent read/write trial may then be performed using the new value for the memory training parameter, whereupon further intermediate results may be generated (after which further adjustment to the memory training parameter value for the given DLL can be made). In various embodiments, a memory controller containing parameter adjustment circuit 210 may train multiple DLLs at once in parallel. Parallel training may occur via multiple memory controller channels in some embodiments. Further, a system with multiple memory controllers may also train those controllers simultaneously or in parallel as well.

Parameter adjustment circuit 210 is also configured to determine an operating value for one or more memory training parameters. Accordingly, in one embodiment, parameter determination logic 220 is configured to perform calculations on intermediate results of a plurality of read/write trials to calculate an operating value. Such calculations may involve determinations of a “left edge” and/or a “right edge” of a delay value for a given DLL. For example, if the intermediate results consist of the following timing parameter values and pass/fail indications for different read/write trials:

| DQ/DQS Offset Fraction | Pass/Fail |
|---|---|
| 0/8 | FAIL |
| 1/8 | PASS |
| 2/8 | PASS |
| 3/8 | PASS |
| 4/8 | PASS |
| 5/8 | FAIL |
| 6/8 | FAIL |
| 7/8 | FAIL |

then a “left edge” of ⅛ (first successful value) and a “right edge” of 4/8 (last successful value) can be determined. From this information, an operating value of 5/16 could be calculated by averaging the left edge and right edge values. Other methods of determining an operating value can also be performed, such as weighted averaging, if quantitative data such as the number of bit or byte errors were available for each trial. An operating value could also be determined using iterative testing—for example, additional read/write trials within the left edge of ⅛ and right edge of 4/8 could be run, after which an operating value would be calculated using the additionally generated data. After one or more operating values are determined, they can be stored in results storage 230, in dedicated registers (e.g., within registers within parameter adjustment circuit 210 or within the DLLs themselves), or any other suitable location as would occur to one with skill in the art. In one embodiment, parameter operating values may be stored in BIOS.

Voltage memory parameters may also be trained by parameter adjustment circuit 210 and control circuit 260. Thus in one embodiment, control circuit 260 is configured to perform a test of memory element 180 by varying both a voltage parameter and a timing parameter. Such a test may be performed for a given DLL, for example, by determining an operating value of a timing parameter for that DLL at one voltage level, then raising or lowering the voltage level and conducting additional read/write trials to determine one or more other operating values for the timing parameter at the other voltages. For example, the results of such testing could take the form:

| Channel Voltage Level | Timing Parameter Operating Value |
|---|---|
| 1.60 v | 9/32 |
| 1.55 v | 9/32 |
| 1.50 v | 8/32 |
| 1.45 v | 7/32 |

After determining various timing settings for different voltage levels, the memory channel controller could pick an appropriate timing parameter operating value accordingly (e.g., using different timing values for voltages of different memory channels, or picking different timing values in response to voltage level fluctuations during system operation). Thus, in one embodiment, for each of a plurality of voltage parameter values, a respective plurality of read/write trials on the memory element using that voltage parameter value could be performed according to methods outlined above to determine a timing parameter operating value for that voltage level.

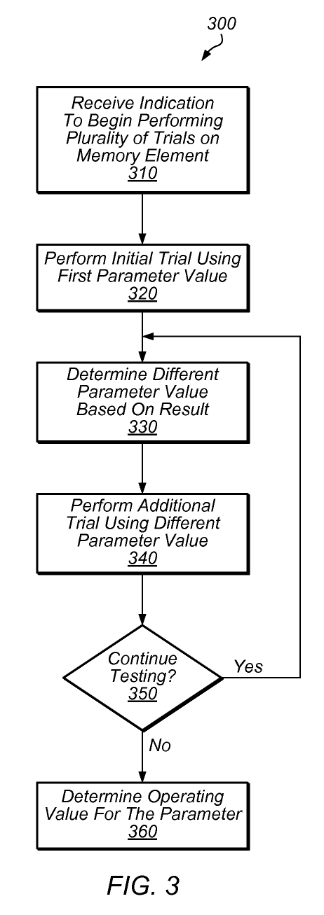

Turning now to FIG. 3, a flowchart of a method 300 for determining a parameter operating value is shown. In various embodiments, the steps of method 300 are performed wholly or in part by parameter adjustment circuit 210 and control circuit 260.

In step 310, an indication to begin performing a plurality of read/write trials on a memory element is received. As described above, such an indication may be generated automatically in response to a system powering on, changed environmental conditions (voltage, temperature, other), or to a hardware or software timer. Such an indication may be received from a BIOS device in some embodiments. An indication to begin testing may also include additional information, such as a particular address range to be tested.

In step 320, an initial read/write trial is performed using a first value for a memory training parameter. In various embodiments, this initial value may be preset, dynamically determined, or specified in the indication to begin testing. For example, an initial read/write trial may use a DQ/DQS timing delay value of zero for a particular DLL. Data would then be written to and read from memory to determine if that timing delay value produced correct results.

In step 330, based on the result of the initial trial, a different value for the memory training parameter is determined. In some embodiments, this step may include incrementing the DQ/DQS timing delay value by a fixed amount (e.g., some fraction of a clock cycle). In other embodiments, the timing delay value might be incremented by a dynamically determined amount (e.g., in response to quantitative data regarding the number of bit or byte errors from the previous trial). Note that while various examples herein refer to “incrementing” memory training parameter values during testing, other mathematical operations to change the value are equally possible, such as decrementing (subtracting), multiplication, or division. Thus, a different parameter value may be determined based on one or more previous results.

In step 340, an additional read/write trial is performed using the newly determined parameter value from step 330. Step 340 may include any or all of the elements described above with respect to step 320. In step 350, a determination is made as to whether to continue testing for the particular memory parameter(s) in question. For example, if a left edge has already been detected, testing might be halted when a right edge is also detected (e.g., halting testing after detection of one or more failures subsequent to one or more previously detected successes). Alternatively, in some embodiments, testing might be continued until an entire range of possible values have been evaluated. If it is determined to continue testing for the particular parameter(s), the method reverts to step 330 and proceeds as outlined above. If it is determined that no further testing should occur, however, then in step 360, an operating value for the particular memory parameter is determined. This determination can be made in any manner as outlined above (e.g., left edge/right edge averaging, weighted averaging, etc.) or as would occur to one skilled in the art.

In some embodiments, steps 320-360 are performed without reporting results to a BIOS device. Accordingly, in these embodiments, operating parameter values may be determined without any intermediation or decision-making by the BIOS of a computer system such as system 400. This may greatly speed the memory parameter training process, as in many computer systems, one or more memory controllers are a part of (or connected to) the Northbridge, while the BIOS is attached to a significantly slower Southbridge. As previously noted, in some embodiments, a BIOS may initiate memory training by sending an indication to one of parameter adjustment circuit 210 or control circuit 260, but not necessarily take any further action until training is complete. Further, in embodiments where the BIOS takes no role in memory training after an initial startup phase, the BIOS may be free to perform other operations needed to boot up the computer system (thus speeding overall boot time even more).

As can be seen from the above disclosure, in one embodiment, control circuit 260 is a means for performing a test of a memory element using one or more memory training parameters, and parameter adjustment circuit 210 is a means for receiving an intermediate result of the test and adjusting at least one of the one or more memory training parameters based on the intermediate result.

### Exemplary Computer System

Turning now to FIG. 4, one embodiment of an exemplary computer system 400, which may include memory controller 105, is depicted. Computer system 400 includes a processor subsystem 480 that is coupled to a system memory 420 and I/O interfaces(s) 440 via an interconnect 460 (e.g., a system bus). I/O interface(s) 440 is coupled to one or more I/O devices 450. Computer system 400 may be any of various types of devices, including, but not limited to, a server system, personal computer system, desktop computer, laptop or notebook computer, mainframe computer system, handheld computer, workstation, network computer, a consumer device such as a mobile phone, pager, or personal data assistant (PDA). Computer system 400 may also be any type of networked peripheral device such as storage devices, switches, modems, routers, etc. Although a single computer system 400 is shown for convenience, system 400 may also be implemented as two or more computer systems operating together.

Processor subsystem 480 may include one or more processors or processing units. For example, processor subsystem 480 may include one or more processing units (each of which may have multiple processing elements or cores) that are coupled to one or more resource control processing elements 420. In various embodiments of computer system 400, multiple instances of processor subsystem 480 may be coupled to interconnect 460. In various embodiments, processor subsystem 480 (or each processor unit or processing element within 480) may contain a cache or other form of on-board memory. In one embodiment, processor subsystem 480 may include memory controller 105 described above.

System memory 420 is usable by processor subsystem 480, and comprises one or more memory elements such as element 180 in various embodiments. System memory 420 may be implemented using different physical memory media, such as hard disk storage, floppy disk storage, removable disk storage, flash memory, random access memory (RAM—static RAM (SRAM), extended data out (EDO) RAM, synchronous dynamic RAM (SDRAM), double data rate (DDR) SDRAM, RAMBUS RAM, etc.), read only memory (ROM—programmable ROM (PROM), electrically erasable programmable ROM (EEPROM), etc.), and so on. Memory in computer system 400 is not limited to primary storage such as memory 420. Rather, computer system 400 may also include other forms of storage such as cache memory in processor subsystem 480 and secondary storage on I/O Devices 450 (e.g., a hard drive, storage array, etc.). In some embodiments, these other forms of storage may also store program instructions executable by processor subsystem 480.

I/O interfaces 440 may be any of various types of interfaces configured to couple to and communicate with other devices, according to various embodiments. In one embodiment, I/O interface 440 is a bridge chip (e.g., Southbridge) from a front-side to one or more back-side buses. I/O interfaces 440 may be coupled to one or more I/O devices 450 via one or more corresponding buses or other interfaces. Examples of I/O devices include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 400 is coupled to a network via a network interface device.

Program instructions that are executed by computer systems (e.g., computer system 400) may be stored on various forms of computer readable storage media. Generally speaking, a computer readable storage medium may include any non-transitory/tangible storage media readable by a computer to provide instructions and/or data to the computer. For example, a computer readable storage medium may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), as well as storage media accessible via a communication medium such as a network and/or a wireless link.

In some embodiments, a computer-readable storage medium can be used to store instructions read by a program and used, directly or indirectly, to fabricate hardware for parameter adjustment circuits 110 and/or 210 and control circuits 120 and/or 260 as described above. For example, the instructions may outline one or more data structures describing a behavioral-level or register-transfer level (RTL) description of the hardware functionality in a high level design language (HDL) such as Verilog or VHDL. The description may be read by a synthesis tool, which may synthesize the description to produce a netlist. The netlist may comprise a set of gates (e.g., defined in a synthesis library), which represent the functionality of parameter adjustment circuits 110 and/or 210 and control circuits 120 and/or 260. The netlist may then be placed and routed to produce a data set describing geometric shapes to be applied to masks. The masks may then be used in various semiconductor fabrication steps to produce a semiconductor circuit or circuits corresponding to parameter adjustment circuits 110 and/or 210 and control circuits 120 and/or 260.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A memory controller, comprising:
a control circuit configured to perform a test of a memory element using one or more memory training parameters; and
a parameter adjustment circuit configured to receive an intermediate result of the test and adjust at least one of the one or more memory training parameters based on the intermediate result.

2. The memory controller of claim 1, wherein the at least one of the one or more memory training parameters is a timing parameter; and
wherein the parameter adjustment circuit is configured to determine one or more operating values for the timing parameter based on a plurality of intermediate results.

3. The memory controller of claim 1, wherein the intermediate result of the test includes an indication that one or more of a plurality of read/write trials of the memory element have been completed using a given value for the one or more memory training parameters; and
wherein the parameter adjustment circuit is configured to adjust the at least one of the one or more memory training parameters to a value other than the given value based on the indication that one or more of the plurality of read/write trials of the memory element have been completed.

4. The memory controller of claim 3, wherein the memory element comprises a plurality of groups of storage bytes; and
wherein the control circuit is configured to perform the test of the memory element by providing, for each of the plurality of groups of storage bytes, a respective plurality of timing parameter values to a delay-locked loop dedicated to that group of storage bytes.

5. The memory controller of claim 1, wherein the parameter adjustment circuit is configured to perform the test by performing a plurality of read/write trials on the memory element using a plurality of values for the at least one of the one or more memory training parameters;
wherein the memory controller is further configured to determine an operating value for the at least one of the one or more memory training parameters by performing calculations on results of the plurality of read/write trials.

6. The memory controller of claim 1, wherein the control circuit is configured to perform the test of the memory element by varying a voltage parameter and a timing parameter.

7. The memory controller of claim 6, wherein the parameter adjustment circuit is configured to perform, for each of a plurality of voltage parameter values, a respective plurality of read/write trials on the memory element using that voltage parameter value, wherein each of the respective plurality of read/write trials uses a different timing parameter value.

8. The memory controller of claim 7, wherein the memory controller is configured to determine a plurality of operating timing parameter values for the memory element, wherein each of the plurality of operating timing parameter values corresponds to at least a respective one of the plurality of voltage parameter values.

9. The memory controller of claim 5, wherein the memory controller is configured to determine the operating value by averaging a left edge value and a right edge value.

10. A method, comprising:
a memory controller performing a plurality of trials of a memory element, wherein an initial one of the plurality of trials uses a first value for a timing parameter, wherein subsequent ones of the plurality of trials each use a respectively different value for the timing parameter, wherein the respectively different value is determined by the memory controller based on results of one or more previously performed ones of the plurality of trials of the memory element; and
the memory controller determining an operating value for the timing parameter based on results of the plurality of trials.

11. The method of claim 10, wherein said performing the plurality of trials of the memory element does not depend on reporting the results of the plurality of trials to a BIOS device.

12. The method of claim 10, wherein the memory element includes a plurality of groups of storage bytes;
wherein performing the plurality of trials of the memory element includes:
performing writes to different ones of the plurality of groups of storage bytes via different ones of a plurality of delay-locked loops; and
performing reads of the different ones of the plurality of groups of storage bytes.

13. The method of claim 12, further comprising the memory controller determining a plurality of operating values for the timing parameter, wherein each of the plurality of determined operating values corresponds to at least one of the plurality of delay-locked loops.

14. The method of claim 10, wherein said performing the plurality of trials of the memory element is in response to an indication of changed environmental conditions.

15. The method of claim 10, further comprising the memory controller determining a range of operating values for the timing parameter based on the results of the plurality of trials, wherein the determined operating value is in the range.

16. An apparatus, comprising:
means for performing a test of a memory element using one or more memory training parameters; and
means for receiving an intermediate result of the test and adjusting at least one of the one or more memory training parameters based on the intermediate result.

17. The apparatus of claim 16, wherein the at least one of the one or more memory training parameters is a timing parameter; and
wherein the apparatus further comprises means for determining one or more operating values for the one or more memory training parameters based on a plurality of intermediate results.

18. The apparatus of claim 16, wherein the intermediate result of the test includes an indication that one or more of a plurality of read/write trials of the memory element have been completed using a given value for the one or more memory training parameters; and
wherein the apparatus further comprises means for adjusting the at least one of the one or more memory training parameters to a value other than the given value based on the indication that one or more of the plurality of read/write trials of the memory element have been completed.

19. A computer readable storage medium comprising a data structure which is operated upon by a program executable on a computer system, the program operating on the data structure to perform a portion of a process to fabricate an integrated circuit including circuitry described by the data structure, the circuitry described by the data structure including:
a control circuit configured to perform a test of a memory element using one or more memory training parameters; and
a parameter adjustment circuit configured to receive an intermediate result of the test and adjust at least one of the one or more memory training parameters based on the intermediate result.

20. The computer readable storage medium of 19, wherein the storage medium stores hardware description language (HDL) data, Verilog data, or graphic database system II (GDSII) data.
